(19) United States
(12) Patent Application Publication
(10) Pub. No.: US 2020/0334515 A1
(43) Pub. Date: Oct. 22, 2020

(54) FLUID PUMP FOR GROUNDWATER WELLS WITH CYCLE COUNTER

(71) Applicant: Q.E.D. Environmental Systems, Inc., Dexter, MI (US)

(72) Inventors: John F. SCHAUPP, Dexter, MI (US); David A. FISCHER, Dexter, MI (US); Leonard Felton STEVENS-MOMAN, Dexter, MI (US); William C. ALLEN, III, Dexter, MI (US)

(73) Assignee: Q.E.D. Environmental Systems, Inc., Dexter, MI (US)

(21) Appl. No.: 16/756,893

(22) PCT Filed: Oct. 31, 2018
(86) PCT No.: PCT/US2018/058389

§ 371 Date: Apr. 17, 2020

Related U.S. Application Data
(60) Provisional application No. 62/579,574, filed on Oct. 31, 2017.

(51) Int. Cl. G06M 1/10; G01D 5/14

(52) U.S. Cl. CPC G06M 1/102; G01D 5/145

(57) ABSTRACT

The present disclosure relates to a cycle counter apparatus for use with an air-driven fluid pump. The apparatus may have a main housing having a bore in communication with a pressurized fluid signal being applied to remove a liquid from a location filling with the liquid. A magnet housing may be included which is moveable linearly within the bore of the main housing in response to the pressurized fluid signal entering the bore. A magnet may be secured to the magnet housing. A switch housing may be included which is operably associated with the main housing and which includes first and second longitudinally spaced apart sensing components. The sensing components are used to detect movement of the magnet in response to the pressurized fluid signal.

### CROSS-REFERENCE TO RELATED APPLICATIONS

This application is a PCT International Application of U.S. Provisional Patent Application No. 62/579,574 filed on Oct. 31, 2017. The entire disclosure of the above application is incorporated herein by reference.

### FIELD

The present disclosure relates to fluid pumps for use with wells, and more particularly to a cycle counter system for use with a fluid pump used in dewatering a wellbore of a well, as well gas extraction applications, and which is able to even more accurately count the On/Off cycles of the fluid pump.

### BACKGROUND

This section provides background information related to the present disclosure which is not necessarily prior art.

With fluid pumps such as groundwater sampling pumps, a cycle counter has often been included as a subsystem of the pump for counting the number of cycles that the pump cycles on and off. Typically these pulse counter subsystems have involved the use of a non-mechanical counter, or in some instances the use of a reed switch, which works together with a linearly movable component, often referred to as a “shuttle”. The shuttle typically includes a magnet, and the magnet is typically positioned in a center of the shuttle. The shuttle typically uses a spring which applies a spring force to the shuttle which biases the shuttle towards a home location. The shuttle includes an air passage that is able to receive an air flow signal, and when the air flow signal is acting on the shuttle, an air pressure differential is created. The air flow differential creates pressure that pushes the shuttle to an equilibrium position.

One drawback of the above described construction is that the shuttle is allowed to travel a relatively long distance as it moves from its home position to its equilibrium position (i.e., its “stop” or end of stroke position). In some instances, this results in the reed switch changing state or “count” multiple times when only a single state change (i.e., detection of a single pump On/Off cycle) should have occurred. The multiple state changes are caused by multiple magnetic flux fields which are presented to the reed switch as the shuttle is moved from the home position to its end-of-stroke position. Another disadvantage with present day devices is the need to adjust/calibrate the counter for each well and/or well condition.

Accordingly, it would be highly useful to provide a cycle counter system and method which is not susceptible to varying magnetic flux fields caused by movement of the shuttle.

### SUMMARY

This section provides a general summary of the disclosure, and is not a comprehensive disclosure of its full scope or all of its features.

The present disclosure relates to a cycle counter apparatus for use with an air-driven fluid pump. In one embodiment the apparatus may comprise a main housing having a bore in communication with a pressurized fluid signal being applied to remove a liquid from a location filling with the liquid. A magnet housing may be included which is moveable linearly within the bore of the main housing in response to the pressurized fluid signal entering the bore. A magnet may be secured to the magnet housing. A switch housing may be included which is operably associated with the main housing and which includes first and second longitudinally spaced apart sensing components. The sensing components are used to detect movement of the magnet in response to the pressurized fluid signal.

In another aspect the present disclosure is directed to a cycle counter apparatus for use with an air-driven fluid pump. The apparatus may include a main housing having an inlet, an outlet and a bore extending between the inlet and the outlet. The inlet and the bore are both in communication with a pressurized fluid signal being applied to remove a liquid from a wellbore filling with the liquid. The apparatus may further include a magnet housing moveable linearly within the bore of the main housing from a first position to a second position in response to the pressurized fluid signal entering the bore. A magnet may be secured to the magnet housing, and a switch housing is releasably secured to the main housing generally parallel to the main housing. The first and second longitudinally spaced apart sensing components may be disposed within the switch housing for detecting movement of the magnet in response to the pressurized fluid signal. Detection of the movement of the magnet provides an indication of cycling of the air driven fluid pump. A biasing element may also be included which is disposed within the bore of the main housing. The biasing element provides a biasing force to bias the magnet housing toward into the first position when no pressurized fluid signal is being received in the bore.

In still another aspect the present disclosure is directed to a cycle counter apparatus for use with an air-driven fluid pump. The apparatus may comprise a main housing having an inlet, an outlet and a bore extending between the inlet and the outlet. The inlet and the bore are both in communication with a pressurized fluid signal being applied to remove a liquid from location filling with the liquid. A magnet housing may be included which is moveable linearly within the bore of the main housing from a first position to a second position in response to the pressurized fluid signal entering the bore. A magnet may be positioned within the magnet housing. A stroke limiter may be secured to the outlet of the main housing for limiting linearly movement of the magnet housing while allowing the pressurized fluid to exit the outlet of the main housing. A switch housing may be releasably secured to the main housing generally parallel to the main housing. The switch housing may include a plurality of circumferential arms to enable attachment and removal of the switch housing. First and second longitudinally spaced apart sensing components may be disposed within the switch housing for detecting movement of the magnet in response to the pressurized fluid signal. Detection of the movement of the magnet provides an indication of cycling of the air driven fluid pump. A biasing element may also be disposed within the bore of the main housing to provide a biasing force to bias the magnet housing toward into the first position when no pressurized fluid signal is being received in the bore.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a high level illustration illustrating a cycle counter system in accordance with one embodiment of the present disclosure being used at a wellhead;

FIG. 2 is an exploded perspective view of the cycle counter system shown in FIG. 1;

FIG. 3 is a cross sectional view of the cycle counter system shown in FIG. 1, taken along section line 3-3 in FIG. 1, with its internal magnet at its home position;

FIG. 4 is a view of the cycle counter system of FIG. 3 but with the magnet at its end-of-travel position;

FIG. 5 is an elevational view of the magnet retainer showing the slot that allows airflow through the magnet retainer;

FIG. 6 is one example of the look-up table indicated in FIG. 1;

FIG. 7 is another embodiment of the present disclosure that makes use of one reed switch and one ratiometric Hall Effect sensor to enable ratiometric sensing of the axial movement of the magnet mounted within the switch housing; and

FIG. 8 shows another embodiment of the magnet housing which increases the sensitivity of the magnet housing to low flows.

Corresponding reference numerals indicate corresponding parts throughout the several views of the drawings.

### DETAILED DESCRIPTION

Example embodiments will now be described more fully with reference to the accompanying drawings.

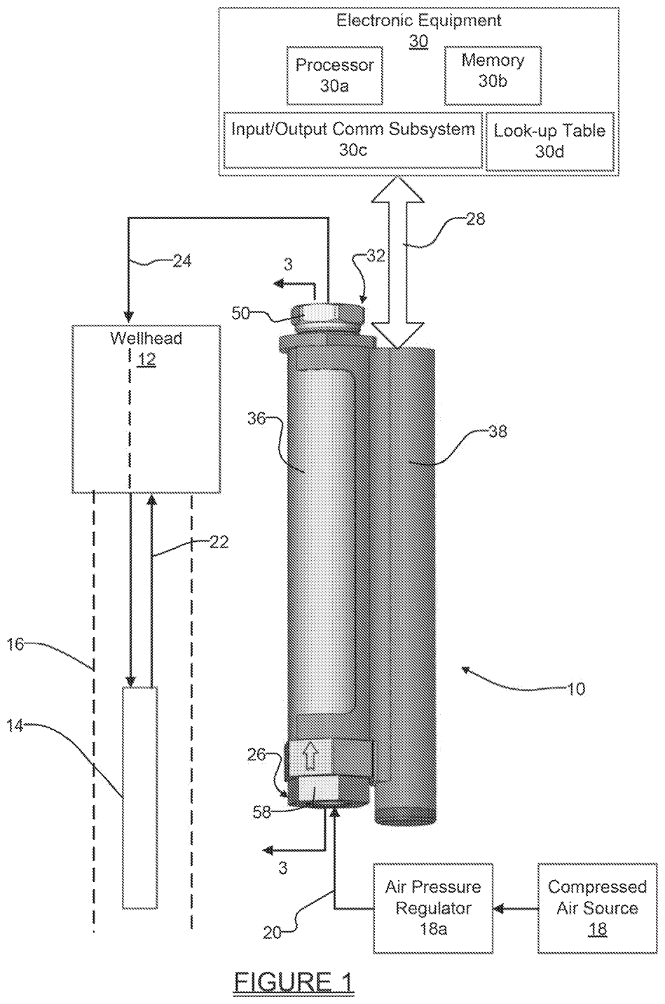

Referring to FIG. 1 there is shown a cycle counter system 10 in accordance with one embodiment of the present disclosure. The system 10 is illustrated positioned adjacent a wellhead 12, where the wellhead 12 is in communication with a fluid pump 14 positioned in a wellbore 16. In this example the pump 14 is a pneumatically driven pump with an internal float assembly. Pumps of this type of construction are widely used in leachate pumping applications and are available from the assignee of the present application. Such pumps typically receive compressed air from a compressed air source 18, an air pressure regulator 18a, and a suitable air line 20. When the float signals that the fluid level in the wellbore 16 has risen to a predetermined height, the float assembly opens a valve that admits compressed air into an interior area of the pump 14, thus displacing the fluid collected in the interior area up through a fluid line 22 to the wellhead 12 and out through the wellhead. More specifically, when the internal valve of the pump 14 opens to admit air, then compressed air is supplied from the air pressure regulator 18a through air line 20 (e.g., a rubber hose) to the air inlet end 26 of the system 10, and then out from the system 10 and through an air supply line 24 into the interior area of the pump. The presence of this compressed air signal is sensed by the system 10, which generates an electrical signal on one or more electrical conductors 28. The electrical signal indicates that the pump 12 has cycled from its OFF state to its “ON” state. The signal may be monitored by external electronic equipment 30 to track operation of the pump 12.

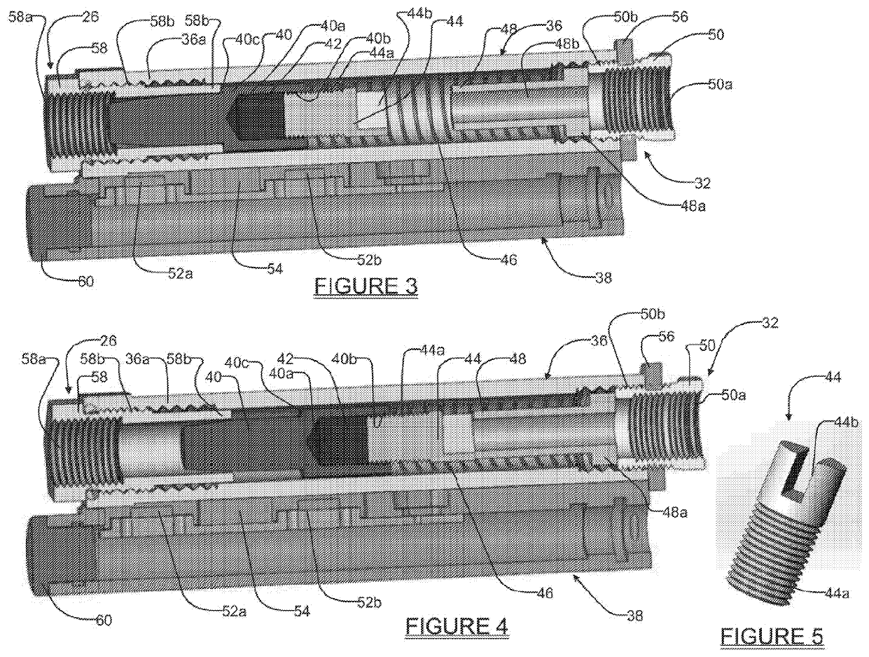

The external electronic equipment 30 may be located at the wellhead 12 or may be located remotely from the wellhead. Both implementations are contemplated by the present disclosure. The external electronic equipment 30 may include, but is not limited to, a processor 30a, a memory (e.g., non-volatile memory such as RAM and/or ROM) 30b, and an input/output communications subsystem 30c. The memory 30b may include a look-up table 30d which the processor 30a may use in determining a cycle count of the pump 12 from electrical signals received over conductors 28. The look-up table 30d will be discussed further in connection with the operation of the system 10 and FIGS. 3 and 4.

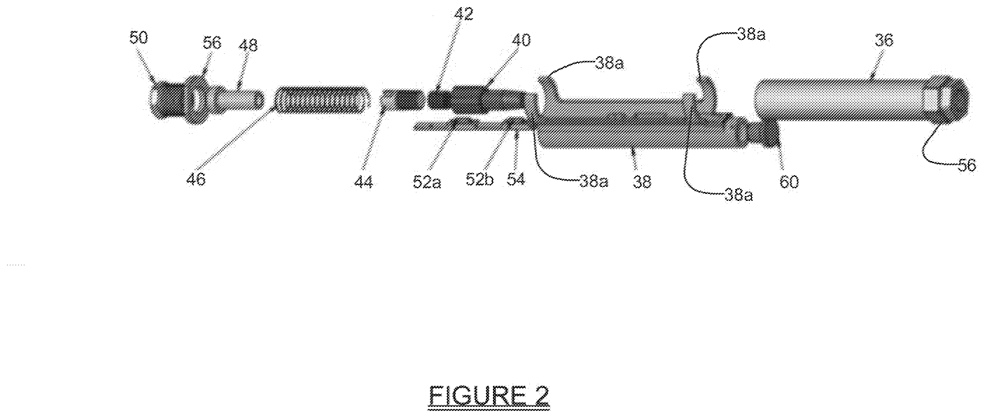

Referring to FIGS. 2 and 3, the various components of the system 10 can be seen in greater detail. The system 10 includes a main housing 36, a switch housing 38, a magnet housing 40, a magnet 42, and a magnet retainer 44. Further included are a spring 46, a stroke limiter 48 having a through bore 48b, and a bushing 50 that forms the outlet end of the system 10. It will be appreciated that the stroke limiter 48 may also include a plurality radially arranged holes (not shown) in addition to the through bore 48b to even further help with enabling air flow through the stroke limiter 48.

A pair of normally open (“NO”) reed switches 52a and 52b are fixedly mounted, such as via adhesives, on a reed switch mounting plate 54. Alternatively, the NO reed switches 52a and 52b could be “Normally Closed” (NC) reed switches, and both implementations are envisioned. A threaded nut 56 allows the bushing 50 to be locked into place to prevent unthreading of the bushing 50 during operation of the system 10. In this regard the bushing 56 can be seen in FIG. 3 to include internal threads 50a as well as external threads 50b. The external threads 50b engage with internal threads of the nut 56. A threaded fitting 58, which includes internal threads 58a and external threads 58b, is threaded into a threaded end 36a of the main housing 36 and forms a means by which a threaded air inlet fitting (not shown) may be secured to the main housing 36 to enable compressed air to be admitted to the interior area of the main housing.

As can be seen in FIGS. 3 and 4, the magnet 42 is captured in a bore 40a of the magnet housing 40. Internal threads 40b of the magnet housing 40 engage with external threads 44a of the magnet retainer 44 to secure the magnet within the bore 40a of the magnet housing 40. The spring 46 is positioned over the magnet retainer 44 so that one end (i.e., the left most end in FIGS. 3 and 4) is biased against the magnet housing 40, while its opposite end is biased against a shoulder 48a of the stroke limiter 48. The spring 46 thus maintains the magnet in the axial position shown in FIG. 3 when no compressed air signal is being received at the inlet end 26 of the system 10.

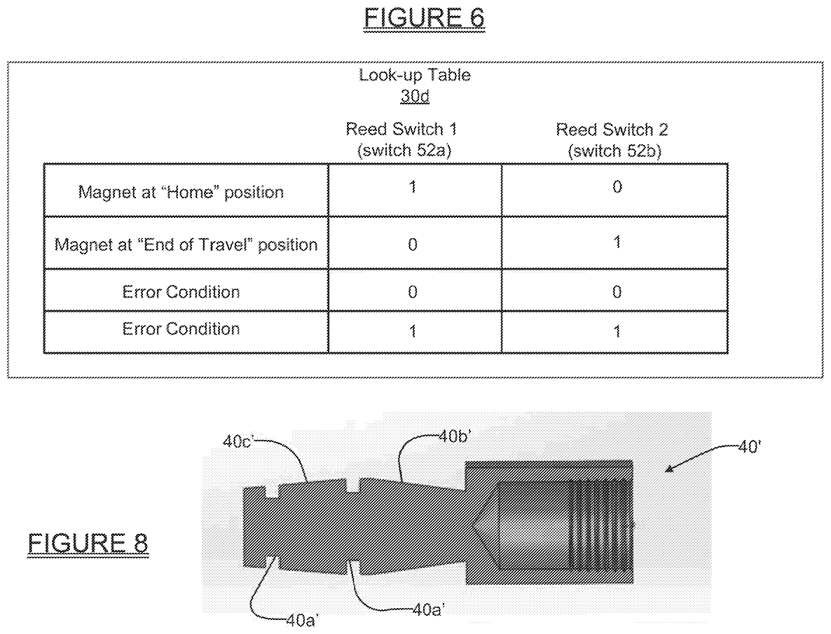

With further reference to FIGS. 3, 4 and 5, preferably the magnet retainer 44 includes a longitudinally extending slot 44b that provides a small cross sectional area for air to escape through to the outlet end 32, as well as function as a slot to enable a tool, for example a screwdriver, to be used to threadably insert the magnet retainer into the magnet housing 40 during assembly of the system 10. Alternatively, the slot 44b could be replaced by one or more holes. If electrical conductors are arranged to run completely through the switch housing 38, then a removable plug 60 may be removed to permit free passage of electrical wiring through the switch housing. If the electrical conductors 28 are arranged to both enter and exit from the same end of the switch housing 38, then the plug 60 may be kept installed on the switch housing. The switch housing 38 may also include one or more arcuate arms 38a, as shown in FIGS. 1 and 2, to enable it to be press fit and retained on the main housing 36, and easily removed without separate tools for servicing if needed. In this regard it will be appreciated that the switch housing 38 may be formed as a single molded component from metal or a suitably high strength plastic, or any other suitable material, and may have an internal diameter just slightly larger than an external diameter of the main housing 36. The arms 38a have a small degree of resiliency to enable the switch housing 38 to be attached with a “snap-like” attachment to the main housing 36.

Referring specifically to FIG. 3, the reed switch mounting plate 54 is shaped to be inserted into and secured within the switch housing 38. This positions the reed switches 52a and 52b closely adjacent the magnet 42 when the magnet is in a “home” position. The home position of the magnet 42 is shown in FIG. 3. An “equilibrium” or “end of travel” position is shown of the magnet is shown in FIG. 4. The end of travel position defines the maximum axial position that the magnet 42 can move to when a compressed air signal is being received through inlet end 26 of the main housing 26.

Referring further to FIGS. 3 and 4, in operation, when the internal float system of the pump 12 detects that the fluid level in the wellbore 16 has risen to a predetermined level, the float signals the internal valve to open and admit compressed air from the compressed air source 18. A portion of this compressed air being admitted to the interior area of the pump 12 is diverted and travels through the air supply line 24, through the inlet end 26, and into the main housing 36. This causes the magnet housing 40 with the internally mounted magnet 42 to be moved from the position shown in FIG. 3 to the position shown in FIG. 4. When in the position shown in FIG. 3, on the reed switch 52a will be sensing the magnetic flux field produced by the magnet 42, and providing an electrical signal to the electronics equipment 30 (FIG. 1) in accordance with this condition. As the magnet housing 40 and the magnet 42 move concurrently axially to the position shown in FIG. 4 against the biasing force of the spring 46, the stroke limiter 48 limits axial movement when the magnet retainer 44 comes into contact with it. This effectively limits the “sight” of the magnetic flux fields to one field only (e.g., the flux field at the south pole, or the north pole, or at a midpoint of the magnet 42). During this axial movement of the magnet 42, the first reed switch 52a will cease sensing the magnetic flux field while the second reed switch 52b detects the magnetic flux field produced by the magnet. In this regard the reed switches 52a and 52b act to provide binary-like signals (i.e., either a logic “1” level signal or a logic “0” level signal) to indicate that either the magnetic flux field is being sensed or is not being sensed. When the first reed switch 52a ceases detecting the magnetic flux field and the second reed switch shortly thereafter begins sensing the magnetic flux field, this sequence of events signifies one half cycle of the pump 12.

When the compressed air signal is removed from the system 10, the spring 46 biases the magnet housing 40 and the internally mounted magnet 42 back into the position shown in FIG. 3, where shoulder 40c of the magnet housing 40 contacts a neck portion 58b of the threaded fitting 58. The second reed switch 52b will cease sensing the magnetic flux field produced by the magnet 42 while the first reed switch 52a again begins sensing the magnetic flux field. This signals one complete cycle of the pump 12. The signals produced by the reed switches 52a in this example are thus digital logic “1” or logic “0” level signals that are received by the external electronic equipment 30.

With brief reference to FIG. 6, one example of the look-up table 30d used by the processor 30a is shown. In this example the detection of the magnetic flux field produced by the magnet 42, by either of the reed switches 52a or 52b, produces a logic level “1” signal, although it will be appreciated this logic could be reversed. If both reed switches are generating a logic “1” level signal, this indicates an error condition, possibly signifying that one of the reed switches has malfunctioned, or that the magnet 42 is possibly stuck at a midpoint between the two reed switches 52a and 52b, or that some malfunction is occurring with the pump 12 which is causing the compressed air signal to be continuously applied to the pump. Likewise, if both reed switches 52a and 52b are generating logic “0” level output signals; this also indicates an error condition.

The time between state changes of the reed switches 52a and 52b will also be detectable by the processor 30a. This time may be used by the processor 30a to extrapolate other potentially important information, such as for example how quickly the pump 12 is emptying fluid once a new pump cycle is initiated. For example, it may be known in advance that one pump cycle should take a predetermined amount of time to complete (e.g., 5 seconds), and if the state changes of the reed switches are separated by a 10-30 second (or greater) time span, then this may indicate the early stage of a pump malfunction. Conversely, if the state changes occur with a shorter time interval than what is expected, then this condition may also indicate a problem with the pump 12, such as, for example, a leak path on the outside of the pump 12 through which fluid escapes, a hole in the discharge tube fitting of the pump, etc. Alternatively, a pneumatic valve failure could easily be detected by the system 10 and would be indicated by a short cycle.

The system 10 thus overcomes the condition where short, momentary axial oscillations in the position of the magnet 42 could potentially cause a single reed switch to sense multiple changes in the magnetic flux field, even though only one pump cycle has occurred. Using the two reed switches 52a and 52b virtually ensures that small oscillations in the magnetic flux field caused by movement of the magnet 42 will not be detected as multiple On/Off cycles of the pump 12.

One or both of the reed switches 52a and 52b can also be converted to ratiometric sensors Hall effect sensors. The use of ratiometric Hall effect sensors will provide even more detail and signal resolution, but will likely require more power to operate. However, the use of ratiometric Hall sensors in place of the reed switches 52a and 52b will enable pump performance activity to be stored and pump characteristics to be monitored and analyzed, in a manner similar to the data produced by the reed switches 52a and 52b. The Hall effect sensors can act as a switch and provide digital state changes just like the reed switches 52a and 52b. The Hall effect sensors can also produce an analog output which can be analyzed for different pumping characteristics. Accordingly, it will be appreciated that only reed switches 52a and 52b may be used, or only one or a pair of Hall effect sensors may be used, or a combination of a reed switch and a Hall effect sensor may be used. All of the foregoing embodiments are contemplated by the present disclosure.

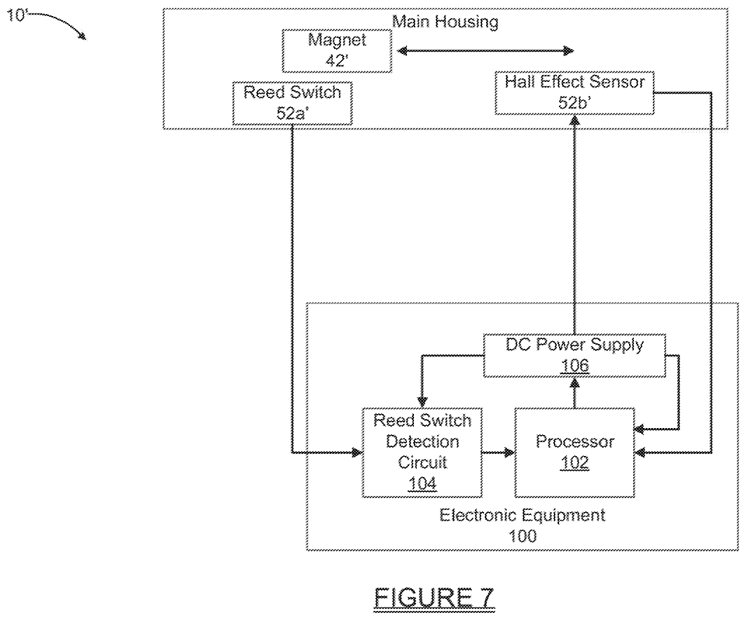

FIG. 7 shows another embodiment 10′ of the present disclosure which makes use of one reed switch 52a′ and one Hall Effect sensor 52b′. Essentially, the Hall Effect sensor 52b′ can simply be substituted in place of the second reed switch 52b, as it is quite similar in dimensions to the second reed switch 52b. Electronic Equipment 100 may include a processor 102, a reed switch detection circuit 104, and a DC power supply 106. In operation, when the reed switch 52a′ changes state as the magnet 42′ moves linearly away from it and the magnetic field loss causes the state change, this condition is detected by the reed switch detection circuit 104. The reed switch detection circuit 104 signals the processor 102 of this condition. The processor 102 signals the DC power supply to then apply power to the Hall Effect sensor 52b. At this point the Hall Effect sensor 52b provides an output signal to the processor 102 which the processor uses to determine not only the axial position, but the rate of axial movement, of the magnet 42′. From this ratiometric information, anomalies in pump 12 operation can be detected.

FIG. 8 illustrates another embodiment of a magnet housing 40′. The magnet housing 40′ in this example includes a plurality of grooves 40a′ and a relatively large chamfer perform 40b′. While the magnet housing 40′ is shown with only two grooves 40a′, it will be appreciated that three, four or possibly even more grooves 40a′ may be included. The grooves 40a′ create turbulence in the air stream between an inside straight wall within which the magnet housing 40′ is positioned and a tapered leading surface 40c′ which increases the magnet housing 40′ sensitivity to low flow and lower pressures. The magnet housing 40′ will move relocating the magnet to a new location to indicate the pump cycle has started. The chamfer portion 40b′ just past the grooves 40a′ has an effect at higher pressures whereby a negative pressure is caused in the chamber. This pressure pulls the magnet housing 40′ back to its home position with the aid of the spring 46 when the air stream velocity is diminishing.

It will also be appreciated that while two reed switches 52a and 52b have been shown, the system 10 is not limited to use with only two reed switches or two Hall Effect sensors. Using three or more reed switches or Hall Effect sensors would provide even greater resolution and a greater amount of data concerning the performance of the pump 12. The use of three or more reed switches may also help to recognize a scenario where pump freezing is beginning to occur. Still another benefit of the system 10 is that it is readily retrofittable for use with existing pumps and wellheads. The only requirement is the connection of an airline that can provide a compressed air signal to the system 10 when the pump is receiving a compressed air signal.

It will also be appreciated that the various embodiments of the system and method described herein may be used with any type of device to track cycle “counts”, and is therefore not limited to any particular counter device or system. As such, the various embodiments described herein may be used with electronic microcontrollers, mechanical tumblers, and any other suitable electronic or mechanical counting devices or systems.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cycle counter apparatus for use with an air-driven fluid pump, the apparatus comprising:
a main housing having a bore in communication with a pressurized fluid signal being applied to remove a liquid from a location filling with the liquid;
a magnet housing moveable linearly within the bore of the main housing in response to the pressurized fluid signal entering the bore;
a magnet secured to the magnet housing;
a switch housing operably associated with the main housing; and
first and second longitudinally spaced apart sensing components disposed within the switch housing for detecting movement of the magnet in response to the pressurized fluid signal.

2. The apparatus of claim 1, wherein at least one of the first and second sensing components comprises a reed switch.

3. The apparatus of claim 1, wherein each of the first and second sensing components comprises a reed switch.

4. The apparatus of claim 1, wherein at least one of the first and second sensing components comprises a Hall effect sensor.

5. The apparatus of claim 1, wherein both of the first and second sensing components comprise Hall effect sensors.

6. The apparatus of claim 1, wherein one of the first and second sensing components comprises a reed switch and the other of the first and second sensing components comprises a Hall effect sensor.

7. The apparatus of claim 1, wherein the first and second sensing components provide electrical output signals indicative of whether the magnet is positioned adjacent thereto.

8. The apparatus of claim 1, further comprising a magnet retainer coupled to the magnet housing to retain the magnet within the magnet housing at a desired location within the magnet housing.

9. The apparatus of claim 8, wherein the magnet retainer includes at least one of a slot or a hole formed thereon to permit passage of the pressurized fluid through the main housing from an inlet end of the main housing to an outlet end of the main housing.

10. The system of claim 1, further comprising a stroke limiter secured to the outlet of the main housing for limiting linearly movement of the magnet housing, while allowing the pressurized fluid to exit the outlet of the main housing.

11. The apparatus of claim 8, wherein the switch housing is releasably coupled to the main housing by at least one pair of arms that partially circumscribe the main housing.

12. The apparatus of claim 1, further comprising a biasing element disposed within the main housing to bias the magnet housing toward an inlet end of the housing, the pressurized fluid acting to overcome a biasing force provided by the biasing element and to move the magnet housing toward an outlet end of the main housing as the pressurized fluid enters and travels through the main housing from the inlet end to the outlet end.

13. The apparatus of claim 12, wherein the biasing element comprises a coil spring.

14. The apparatus of claim 1, wherein the magnet housing includes a tapered leading edge portion, a chamfered portion, and at least one circumferential groove disposed longitudinally between the tapered leading edge portion and the chamfered portion, to help create turbulence when the pressurized fluid enters the main housing and acts on the magnet housing.

15. A cycle counter apparatus for use with an air-driven fluid pump, the apparatus comprising:
a main housing having an inlet, an outlet and a bore extending between the inlet and the outlet, the inlet and the bore both being in communication with a pressurized fluid signal being applied to remove a liquid from a wellbore filling with the liquid;
a magnet housing moveable linearly within the bore of the main housing from a first position to a second position in response to the pressurized fluid signal entering the bore;
a magnet secured to the magnet housing;
a switch housing releasably secured to the main housing generally parallel to the main housing;
first and second longitudinally spaced apart sensing components disposed within the switch housing for detecting movement of the magnet in response to the pressurized fluid signal, and wherein detection of the movement of the magnet provides an indication of cycling of the air driven fluid pump; and
a biasing element disposed within the bore of the main housing and providing a biasing force to bias the magnet housing toward into the first position when no pressurized fluid signal is being received in the bore.

16. The system of claim 15, wherein at least one of the first and second sensing elements comprises a reed switch; and
wherein the biasing element comprises a coil spring.

17. The system of claim 15, wherein at least one of the first and second sensing elements comprises a Hall effect sensor.

18. The system of claim 15, further comprising a stroke limiter secured to the outlet of the main housing for limiting linearly movement of the magnet housing, while allowing the pressurized fluid to exit the outlet of the main housing.

19. The system of claim 15, further comprising a magnet retainer coupled to the magnet housing for retaining the magnet within the magnet housing during movement of the magnet housing.

20. The system of claim 19, wherein the magnet retainer includes a slot formed in a portion thereof slot formed thereon to permit passage of the pressurized fluid through the main housing from the inlet end of the main housing to the outlet end of the main housing.

21. The system of claim 15, wherein the switch housing is releasably secured to the main housing via a pair of circumferential arms.

22. A cycle counter apparatus for use with an air-driven fluid pump, the apparatus comprising:
a main housing having an inlet, an outlet and a bore extending between the inlet and the outlet, the inlet and the bore both being in communication with a pressurized fluid signal being applied to remove a liquid from a wellbore filling with the liquid;
a magnet housing moveable linearly within the bore of the main housing from a first position to a second position in response to the pressurized fluid signal entering the bore;
a magnet positioned within the magnet housing;
a stroke limiter secured to the outlet of the main housing for limiting linearly movement of the magnet housing, while allowing the pressurized fluid to exit the outlet of the main housing;
a switch housing releasably secured to the main housing generally parallel to the main housing, the switch housing including a plurality of circumferential arms to enable attachment and removal of the switch housing;
first and second longitudinally spaced apart sensing components disposed within the switch housing for detecting movement of the magnet in response to the pressurized fluid signal, and wherein detection of the movement of the magnet provides an indication of cycling of the air driven fluid pump; and
a biasing element disposed within the bore of the main housing and providing a biasing force to bias the magnet housing toward into the first position when no pressurized fluid signal is being received in the bore.
